(19) United States
(12) Patent Application Publication
(10) Pub. No.: US 2019/0041000 A1
(43) Pub. Date: Feb. 7, 2019

(54) DRAIN PAN WITH FUNNEL KIT

(71) Applicant: TPG Plastics LLC, Willowbrook, IL (US)

(72) Inventor: Patrick Owen Kelly, Lockport, IL (US)

(21) Appl. No.: 16/053,604

(22) Filed: Aug. 2, 2018

Related U.S. Application Data
(60) Provisional application No. 62/540,297, filed on Aug. 2, 2017.

(51) Int. Cl. F16N 31/00

(52) U.S. Cl. CPC F16N 31/004

(57) ABSTRACT

A system for the disposal of spent automobile fluids, the system including a funnel and a receiving container. The funnel is divided into a funnel body and downspout. The funnel parts are stored in recesses on the surface of the receiving container. The receiving container is configured to receive the spent automobile fluid. The downspout may consist of one or two pieces, the pieces may be coupled to the funnel body, the fillspout, or each other in a number of ways.

### CROSS REFERENCE TO RELATED APPLICATIONS

This application claims benefit of U.S. Provisional Application No. 62/540,297, filed on Aug. 2, 2017, which is herein incorporated by reference in its entirety.

### TECHNICAL FIELD

The present application relates generally to a system comprising a funnel and a sealable, leak-proof, portable container for capturing fluids, for example, during car maintenance, and safely transporting them to authorized disposal facilities. Such will be described with particular reference to the embodiments detailed herein. However, it will be understood that it also finds application in other usage scenarios and is not necessarily limited to the aforementioned application.

### BACKGROUND

Maintenance of motor vehicles often requires removal of spent fluids. Professional service facilities are equipped to efficiently capture and dispose of such fluids, preventing a risk to those performing the services or to the environment. However, private automobile owners performing their own vehicle maintenance may lack the equipment necessary to prevent spilling such fluids during maintenance or in the time intervening between capture and proper disposal of such fluids. Despite efforts to address the above problem, it persists. The innovation presents a new and novel system and method for addressing this issue.

### SUMMARY

The innovation relates to convenient and secure gathering and transportation of fluids (e.g., automobile fluids such as motor oil or transmission fluid).

The construction of the system depicted herein allows for compact storage of all necessary parts and multiple configurations intended to address the myriad of maintenance situations a user may encounter while using the innovation to e.g., perform automobile maintenance.

Other advantages of the innovation will become apparent from the following detailed description when considered in light of the accompanying drawings.

### BRIEF DESCRIPTION OF THE DRAWINGS

The various features, advantages and other uses of the present embodiments will become more apparent by referring to the following detailed description and drawing in which:

FIG. 1 depicts the system configured for storage;

FIG. 2 depicts the system configured for use;

FIG. 3 depicts an alternative downspout; and

FIG. 4 depicts an alternative downspout.

### DETAILED DESCRIPTION

The present innovation relates generally to a system for securely capturing and transporting fluids. According to one aspect of the innovation, the system may be used as part of routine apparatus or vehicle maintenance. Such will be described with particular reference to the embodiments detailed herein. However, it will be understood that it also finds application in other usage scenarios and is not necessarily limited to the aforementioned application.

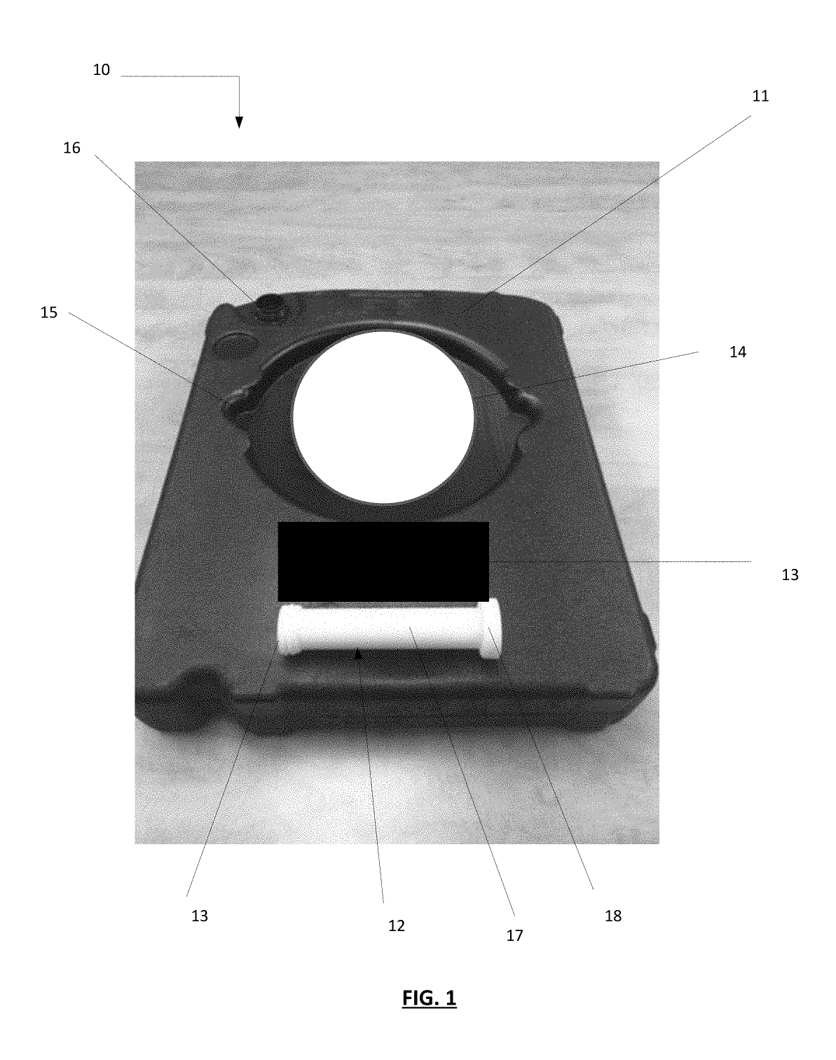

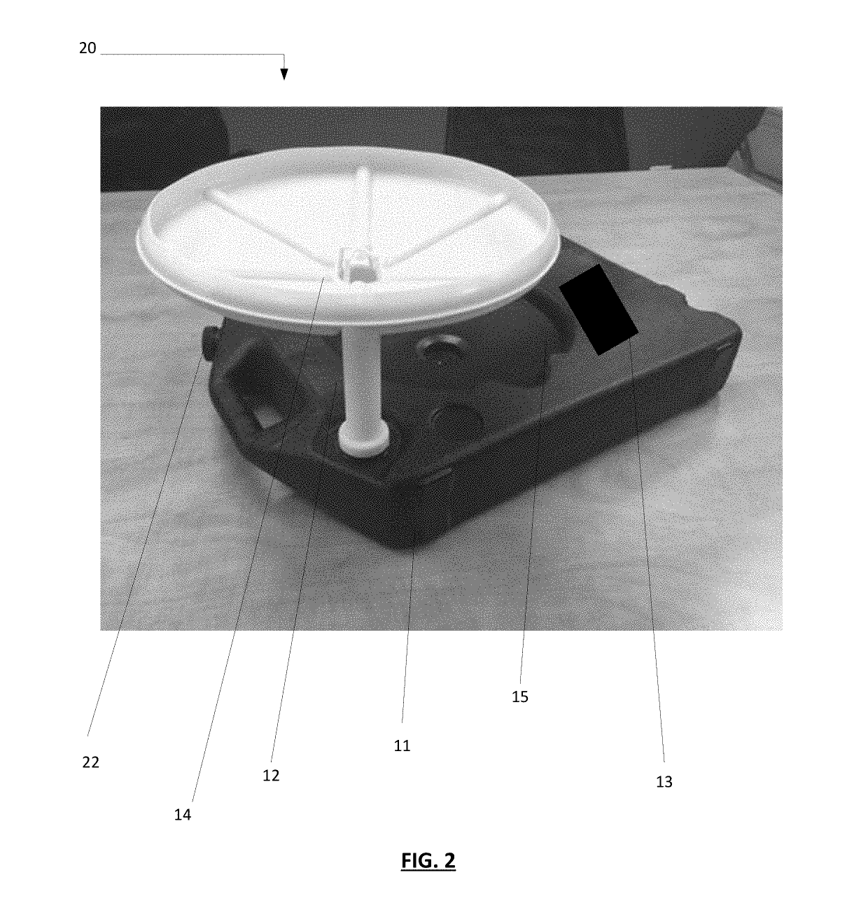

In one aspect of the innovation, the fluid collection system may be configured for the capture and/or storage of fluids from maintenance, such as automobile or engine maintenance. In one embodiment, the system may also include storage of various components for maintenance. In one embodiment, the fluid collection system may include a container comprising a receptacle for receiving and/or storing a fluid, a cap or other means for closing or sealing the receptacle. The receptacle may include a fillspout for receiving the fluid. The system may also include parts used for maintenance, such as a funnel and an adapter for securing the funnel. FIGS. 1-2 are directed toward an embodiment in which a funnel with a one-piece downspout collects automobile fluids during maintenance.

According to one embodiment, FIG. 1 shows a fluid collection system (10) configured for storage. The system includes a container (11) operative to receive fluids. In one embodiment, the container (11) may be substantially leak-proof. The container (11) comprising a fillspout (16) and associated cap, and recesses (13, 15) for storing additional system parts such as a funnel having a body (14), the body (14) consisting of a rim and converging sidewalls, and a one-piece downspout (12). In one embodiment, the one-piece downspout (12) comprises an upper adapter (19), a lower adapter (18), and a spout neck (17). Multiple downspouts (12) of varying lengths and/or widths may be included in the system.

FIG. 2 shows another embodiment of the innovation in which a fluid collection system (20) configured for use. According to this embodiment the upper adapter (19) is removably coupled to the funnel body (14) and the lower adapter (18) is removably coupled to the fillspout (16). According to one embodiment, the upper adapter (19) may contain external threading operative to engage internal threading of the funnel body (14) and the lower adapter (19) may contain internal threading operative to engage external threading on the fillspout (16). FIG. 2 also shows a pourspout (22) operative to eliminate captured fluids from the container (11) during safe disposal.

Alternate means of coupling the downspout (12) to the funnel body (14) and the fillspout (16) may also be used. In one embodiment, the funnel body (14), downspout (12) and fillspout (16) may be coupled using rubber gaskets. Other appropriate means of coupling known in the art may be used as appropriate.

In one embodiment, the container (11) may be leak-proof, but may alternatively leak-resistant, water resistant, or otherwise designed to prevent the loss of fluids captured during maintenance.

According to one embodiment, the downspout (12) may be rigid. Alternatively, the downspout (12) may be flexible. In one embodiment, the downspout (12) may be height-adjustable to facilitate use with machines or device of varying heights. In one embodiment, the system includes a plurality of downspouts (12) of varying lengths and/or widths to accommodate different uses.

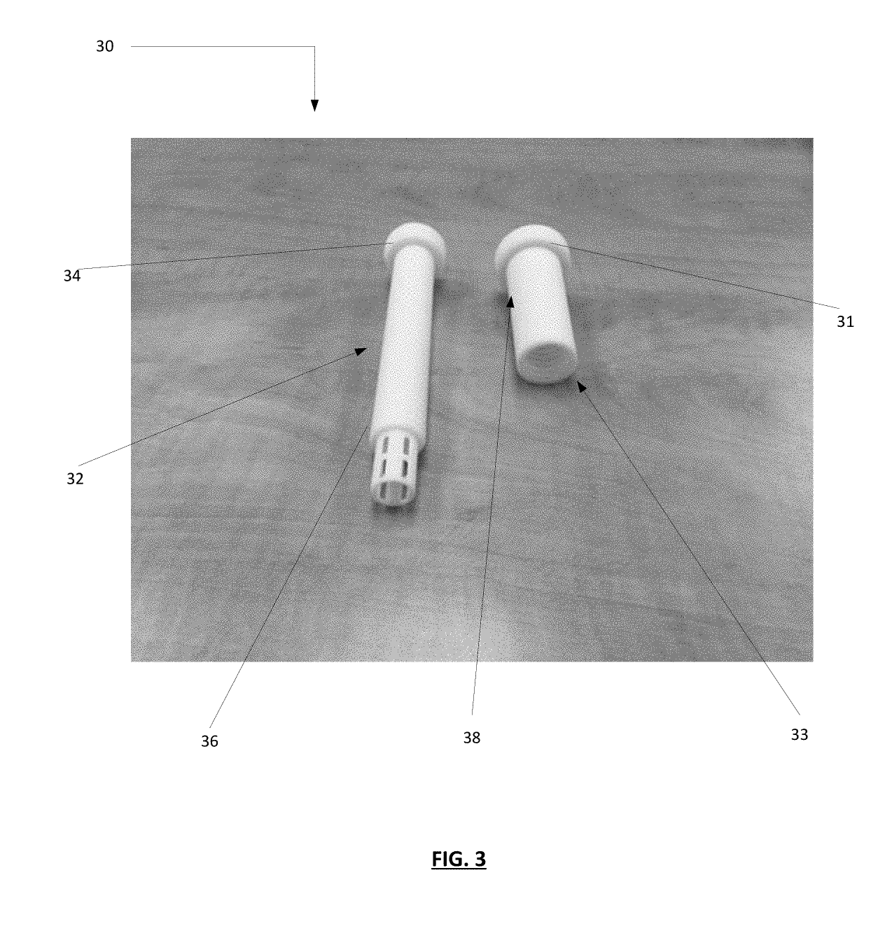

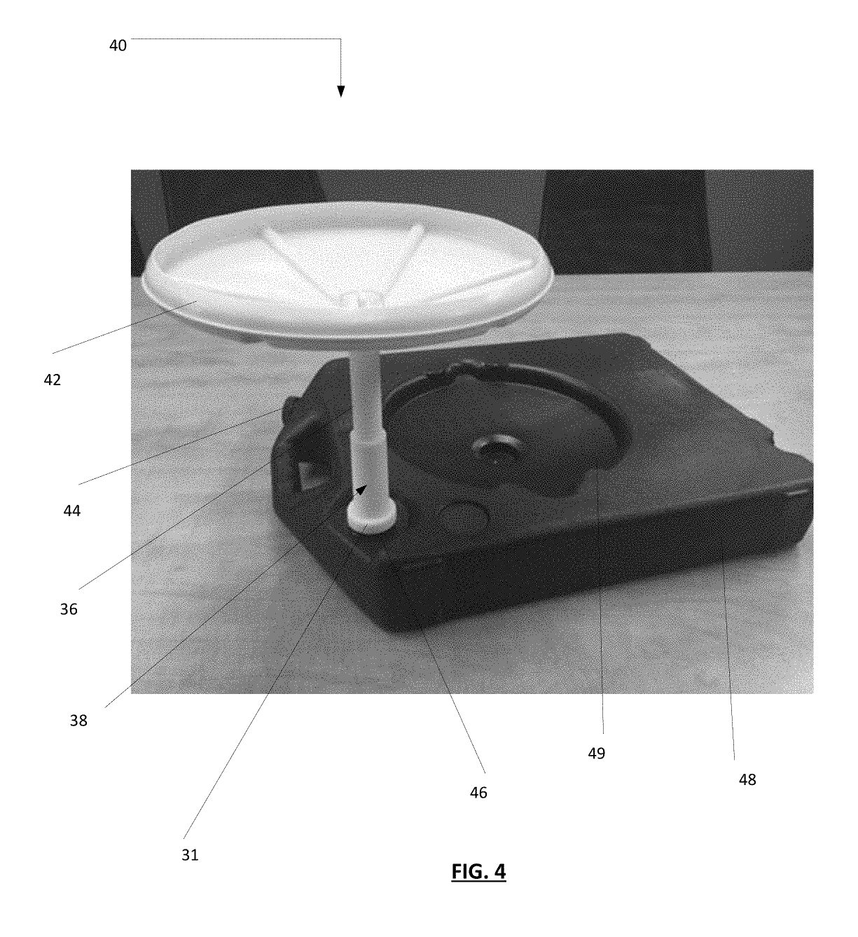

FIGS. 3 and 4 are directed toward embodiments in which a funnel with a two-piece downspout collects automobile fluids during maintenance.

According to one embodiment, FIG. 3 depicts two-piece downspout (30). This two-piece downspout (20) comprises concentric tubes, the first tube (32) having a diameter smaller than that of the second tube (38) and the first tube extending through the second tube. The first tube (32) comprises an upper adapter (34) removably coupled to the funnel body (42), and a spout partially covered in external threading (36), the spout extending into the fillspout, and the second tube (38) comprises a lower adapter (31) with internal threading (33) operative to engage external threading of the fillspout (46) and internal threading operative to engage the external threading (36) of the first tube (32).

In another embodiment the two-piece downspout (30) may be coupled through any appropriate alternative means. In one embodiment, the upper adapter (34) and lower adapter (31) may be coupled to the funnel body (42) and fillspout (46) respectively by rubber gaskets. The first tube (32) and the second tube (38) may be coupled by a connector having separate parts joined by hinges, the two parts being operative to securely fasten the concentric tubes together.

In yet another embodiment, the first tube (32) does not extend into the second tube (38) but instead the first tube (32) and second tube (38) are of equal diameter. In an aspect of the innovation, regarding the upper adapter (34) and the lower adapter (31), one adaptor is a male connector and the other is a female connector (not shown). In another aspect of the innovation, regarding the upper adapter (34) and the lower adapter (31), one adaptor is a spigot and the other is a socket. The above aspects of the innovation may also be applied to an embodiment where the first tube has a greater diameter than the second tube and the second tube (38) extends upward, into the first tube (32).

FIG. 4 shows another embodiment of the fluid collection system (40) configured for use. The system includes a substantially leak-proof container (48) operative to receive spent fluids. The container may include a fillspout (46) and associated cap, a pourspout (44) and associated cap and recesses (49) for storing a funnel having body (42), the body consisting of a rim and converging sidewalls, and a two-piece downspout (30), wherein the funnel components are stored within recesses (49) along surface of the container.

The alternative aspects of the innovation detailed above regarding the two-piece downspout (30) apply equally well to fluid collection system (40) which includes a two-piece downspout (30).

While recited characteristics and conditions of the invention have been described in connection with certain embodiments, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A system for collecting and transporting a fluid, the system comprising:
a container operative to receive spent automobile fluids, the container comprising a fillspout, a pourspout, and recesses for storing additional system parts; and
a funnel having a body, the body consisting of a rim and converging sidewalls, and a one-piece downspout, wherein the funnel components are stored within recesses along the surface of the container.

2. The system according to claim 1, wherein the one-piece downspout comprises an upper adapter, a lower adapter, and a spout neck, the upper adapter being removably coupled to the funnel body and the lower adapter being removably coupled to the fillspout.

3. The system according to claim 2, wherein the upper adapter contains external threading operative to engage internal threading of the funnel body and the lower adapter contains internal threading operative to engage external threading on the fillspout.

4. The system according to claim 1, wherein multiple downspouts of differing lengths are included in the system.

5. A system for collecting and transporting fluids, the system comprising:
a leak-proof container operative to receive fluids the container comprising a fillspout and associated cap, a pourspout and associated cap, and recesses for storing additional system parts; and
a funnel having a body, the body consisting of a rim and converging sidewalls, and a two-piece downspout, wherein the funnel components are stored within recesses along the surface of the container.

6. The system according to claim 5, wherein the two-piece downspout comprises concentric tubes, the first tube having a diameter smaller than that of the second tube and the first tube extending through the second tube.

7. The system according to claim 6, wherein the first tube comprises an upper adapter removably coupled to the funnel body, and a spout partially covered in external threading, the spout extending into the fillspout, and the second tube comprises a lower adapter with internal threading operative to engage external threading of the fillspout and internal threading operative to engage the external threading of the first tube.

8. The system according to claim 5, wherein the two-piece downspout comprises first and second tubes of equal diameter connected by an upper adaptor and a second adaptor.

9. The system according to claim 8, wherein regarding the upper adapter and the lower adapter, one adaptor is a male connector and the other is a female connector.

10. The system of claim 8, wherein regarding the upper adapter and the lower adapter, one adaptor is a spigot and the other is a socket.

11. A funnel operative to capture fluids, the funnel comprising:
a funnel body, comprising a rim and converging sidewalls, and a downspout, wherein the downspout is removably coupled to the funnel body by an upper adapter and removably coupled to a container operative to receive spent fluids by a lower adapter.

12. The funnel of claim 11, wherein the downspout is a one-piece downspout comprising an upper adapter, a spout, and a lower adapter.

13. The funnel of claim 12, wherein the upper adapter contains external threading operative to engage internal threading on the funnel body while the lower adapter contains internal threading operative to engage external threading on the fillspout.

14. The funnel of claim 12, wherein the upper adapter and lower adapter are coupled to the funnel body and fillspout respectively by rubber gaskets.

15. The funnel of claim 11, wherein the downspout is a two-piece downspout comprising concentric tubes, the first tube having a diameter smaller than that of the second tube and the first tube extending through the second tube.

16. The funnel of claim 15, wherein the first tube comprises an upper adapter removably coupled to the funnel body, and a spout that extends through the second tube and into the fillspout, and wherein the second tube is removably coupled to both the first tube and the fillspout.

17. The funnel of claim 16, wherein the upper adapter contains external threading operative to engage internal threading of the funnel body, the lower adapter contains internal threading operative to engage external threading of the fillspout, and part of the spout of the first tube is externally threaded, the external threading of the spout being operative to engage internal threading of the second tube.

18. The funnel of claim 16, wherein the upper adapter and lower adapter may be coupled to the funnel body and fillspout respectively by rubber gaskets.

19. The funnel of claim 16 wherein the first tube and the second tube are coupled together by a rubber gasket.

20. The funnel of claim 16 wherein the first tube and the second tube are coupled by a connector having separate parts joined by hinges the two parts being operative to securely fasten the concentric tubes together.
